(19) United States
(12) Patent Application Publication
(10) Pub. No.: US 2025/0185681 A1
(43) Pub. Date: Jun. 12, 2025

(54) Vegan Cheese Manufacture using Legume Ingredients and Associated Methods

(71) Applicant: GOOD PULSE FOODS LIMITED, Bath (GB)

(72) Inventors: Cesar Enrique Torres Ledezma, Bath (GB); Vincenzo di Bari, Nottingham (GB); Christopher McColm, Driffield (GB); MIchael Alfred James Spurr, Loughborough (GB)

(73) Assignee: GOOD PULSE FOODS LIMITED, Bath (GB)

(21) Appl. No.: 18/788,554

(22) Filed: Jul. 30, 2024

Related U.S. Application Data
(60) Provisional application No. 63/608,832, filed on Dec. 12, 2023.
(60) Provisional application No. 63/530,076, filed on Aug. 1, 2023.

(51) Int. Cl. A23C 20/02; A23J 3/14; A23J 3/22; A23L 11/00

(52) U.S. Cl. CPC A23C 20/025; A23J 3/14; A23J 3/225; A23L 11/05

(57) ABSTRACT

Vegan cheese analogues (VCA) are disclosed that are made from legume derived and/or legume based ingredients. Pea flour can be used where pre-treatment or engineered blending delivers specific functionality to the VCA. The addition of different components such as glycerol monostearate, various starches, various fibres, various oils, and various acids give properties to these VCA's that more closely mimic traditional dairy based cheeses relative to the prior art VCAs.

This application claims priority under 35 USC 119(e) to U.S. Provisional Application No. 63/608,832 filed Dec. 12, 2023, and U.S. Provisional Application No. 63/530,076 filed Aug. 1, 2023, the entire contents of which is incorporated by reference in its entirety.

### FIELD OF THE INVENTION

The present invention discloses legume-derived ingredients such as peas of all types, lupin, Bambara groundnut, peanuts and other groundnuts, chickpeas, haricot beans, cannellini beans, soybeans and all other types of beans and lentils, that deliver highly nutritious and sustainable vegan foods. In one variation, vegan cheese analogues (VCAs) are produced that show the highly promising functionality of the ingredients at producing VCAs that more closely mimic their dairy counterparts. Accordingly, the present invention relates to vegan cheeses that incorporate proteinaceous ingredients from legumes and peas of all types, lupin, Bambara groundnut, peanuts and other groundnuts, chickpeas, haricot beans, cannellini beans, soybeans and all other types of beans and lentils. In one variation, the vegan cheeses of the present invention use legume related protein derived from legume seeds, legume flour, or legume products.

### BACKGROUND OF THE INVENTION

The classification of cheeses can be accomplished using different criteria. One of the most relevant is the composition of the cheese. Based on its composition, different types of cheeses can be distinguished according to the following types of cheeses. These include:
a. Dairy cheeses: derived from milk.
b. Vegan cheeses (vegan cheese analogues): derived from ingredients of non-animal origin including but not limited to vegan cheeses which use fermentation in the production process.
c. Mixed cheeses: derived from mixing ingredients from the components that are present in a and b.

Other criteria can be used to classify cheeses such as their functional properties. These functional properties include the consistency (soft/spreadable, medium, and hard cheeses), meltability and stretch. The functional properties to a large extent are determined by the composition of the cheese and the manufacturing process/manufacturing method.

A lot of vegan cheeses have little to no protein, and many contain just fat and starch. Those that do have protein tend to taste the least like traditional cheeses and they also fail to possess many of the properties of dairy based cheeses such as the ability to melt similar to dairy based cheeses. In particular, many find that when vegan cheeses are used on pizzas or other food products where melting the cheese is imperative, the vegan cheeses are simply inadequate. Vegan cheeses also tend to be somewhat expensive those made from nuts or other nutrient-dense foods can run as much as $12 or more for a small block because they are either made from expensive ingredients (such as nuts and modified starches) or they require large amounts of processing such as isolating the protein from the plant-based sources from which vegan cheeses that contain protein are derived.

Moreover, vegan cheese analogues notoriously have not attained good consistency and/or meltability and/or stretch. Improvements are needed regarding these functional properties. Furthermore, it would also be desirable to manufacture protein-based ingredients for vegan cheeses that are less costly than the currently available methodologies of isolating the proteins. Accordingly, it is with these deficiencies in mind that the presently disclosed invention was developed.

### BRIEF SUMMARY OF THE INVENTION

The present invention relates to ingredients in, and the methods used in the production of vegan cheese analogues (VCAs) that are obtained using legume derived ingredients. These VCAs of the present invention are made using plant-based ingredients with and/or from legumes (after water and in some instances lipids) being the principal ingredient of the VCAs.

As shown in FIG. 1, the VCAs can be characterized and/or distinguished from dairy based cheeses based upon their physical characteristics. The cheeses can be distinguished as follows:
A. Meltable: the cheeses (dairy based and the VCAs) lose their original shape when exposed to high temperatures due to flowing of the mass.
B. Softening: the cheeses retain their original shape only in part (limited flowing) and/or
C. Non-meltable: the cheeses retain their original shape upon exposure to heating.
   In FIG. 1, a block diagram schematic is shown with some examples of dairy and non-dairy derived cheeses displaying different functional melting behaviors.

For the purposes of this application, vegan cheeses may sometimes be referenced as VCA (Vegan Cheese Analogues). Also, the Aqueous phase is sometimes referenced as AP and monoglycerides and chemical modifications thereof as MG.

The vegan cheeses of the present invention also have many of the most desirable attributes of their dairy containing cheese counterparts, including but not limited to firmness, crumbliness, slicing ability, grating ability, stretch, and melt. The present invention delivers many of these properties to an extent that was not heretofore known.

### BRIEF DESCRIPTION OF THE SEVERAL VIEWS OF THE DRAWINGS

FIG. 1 shows a block diagram regarding the meltability of dairy and non-dairy cheeses displaying different responses to heating that include meltable, softening, and non-meltable.

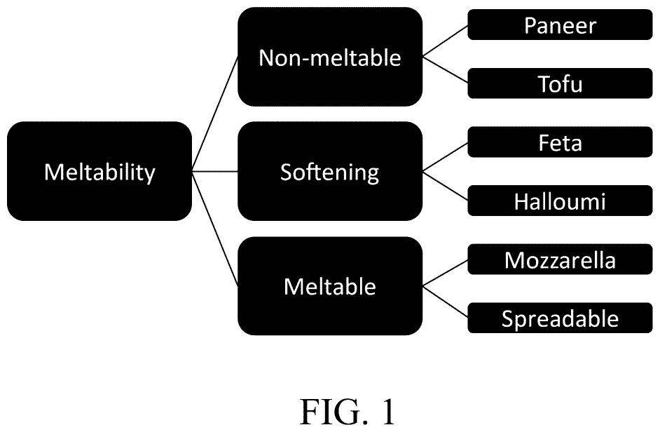

FIG. 2 shows twin screw pressed yellow pea fractions generating the cream fraction (A) and the solid fraction (B).

FIG. 3 shows pH shift protein extraction after centrifugation, showing the supernatant and pellet where different fractions can be used in application of VCAs.

FIG. 4 shows freeze dried materials before milling, with the pH shift supernatant (A), the pH shift pellet (B), and the screw pressed solids (C).

FIG. 5 shows steps in the VCA process with the dry mix (1), mixed to a viscous paste (2), wet premix (3), before processing with the Thermomix (4), after 30 minutes at 50° C. (5), after 30 minutes at 80° C. (6), and after being poured in an aluminum mold (7), production of the VCA is not limited to this equipment.

FIG. 6 shows a texture analyzer set-up (A) and 3 cm cube samples for texture analysis (B).

FIG. 7 shows pea flour VCA, whose composition is shown in Table 1.

FIG. 8 shows pea flour VCA from Table 1 prior to the pre-melt test (A) and after 15 minutes at 150° C. (B).

FIG. 9 shows VCAs with individual pea flour components with 4.4% pea protein (A), 8% pea starch (B), 2.7% pea fibre (C), 4.4% pea protein concentrate with 2.7% pea fibre (D), 4.4% pea protein concentrate, 8% pea starch, and 2.7% pea fibre (E), 4.4% pea protein concentrate, 8% potato starch, and 2.7% pea fibre (F), and a control gel with no added protein, starch, or fibre (G).

FIG. 10 shows VCAs with individual pea flour components before the melting test and after 15 minutes at 150° C. with 4.4% pea protein (A), 8% pea starch (B), 2.7% pea fibre (C), 4.4% pea protein concentrate with 2.7% pea fibre (D), 4.4% pea protein concentrate, 8% pea starch, and 2.7% pea fibre (E), 4.4% pea protein concentrate, 8% potato starch, and 2.7% pea fibre (F), and a control gel with no added protein, starch, or fibre (G).

FIG. 11 shows three VCAs containing 0% pea flour, 3% pea flour and 8% pea flour as a proportion of the AP.

FIG. 12 shows three VCAs before the melting test (left side) and after 15 minutes at 150° C. (right side) with the VCAs containing 0% pea flour, 3% pea flour and 8% pea flour as a proportion of the AP.

FIG. 13 shows a screw-pressed cream based VCA (A), and a screw-pressed solids VCA (B).

FIG. 14 shows the melting test at 150° C. for 15 minutes of pressed solids VCA (A), and the pressed cream VCA (B).

FIG. 15 shows pH shift supernatant VCA (A) and pH shift pellet VCA (B).

FIG. 16 shows the melting test of the pH shift supernatant VCA (A) and the pH shift pellet VCA (B).

FIG. 17 shows the pea flour with 0.8% MG with the VCA composition as shown in Table 10 (A) and the pea flour VCA composition as shown in Table 11 (B).

FIG. 18 shows the melting of a pea flour-based VCA with and without 0.8% MG at 150° C. after 0 minutes, 5 minutes and 15 minutes.

FIG. 19 shows VCA produced with 4.6% protein concentrate from yellow pea protein extract as recited in Table 12 (A), and VCA with 6.8% protein from yellow pea protein extract composition as recited in Table 13 (B).

FIG. 20 shows the melting of VCAs with 4.6% and 6.8% protein from yellow peas at 150° C. after 0 minutes, 5 minutes, and 15 minutes.

FIG. 21 shows results of the melting test with different amounts of GMS (glycerol monostearate) relative to the amount of pea flour (%).

FIG. 22 shows results of the melting test with different amounts of GMS relative to the pea starch amount (%) with x-carrageenan.

FIG. 23 shows a graph that shows the hardness of the VCA relative to time and the amount of coconut oil present.

FIG. 24 shows a graph that shows the hardness of the VCA relative to time and the ratio of coconut oil to rapeseed oil.

FIG. 25 shows the hardness of the VCA relative to the amount of glycerol monostearate (GMS).

FIG. 26 shows the various processing routes that can be followed to drive physical modifications of the macro and micro components of a final legume based ingredient.

### DETAILED DESCRIPTION OF THE INVENTION

### Formulation Considerations

The present invention was designed with contemplation of different approaches to formulating plant-based vegan-cheeses with at least the following ten considerations:
1. Use of commercially available, development, experimental and/or propriety ingredients including but not limited to starches, fibers, proteins and lipids. Examples are in but not limited to the ingredients listed in the Materials section.
2. The use of Pea protein isolate (PPI)+starch/gelators/fibers/gums/lipids: this would rely on:
   A proprietary and/or commercial PPI ingredient: to increase the nutritional value and/or provide structuring/functionality characteristics by boosting protein content up to a maximum of 40%. These can be highly refined ingredient(s) leading to significant waste (currently).
   A range of commercially available starch/gelators/fibers/gum/lipids ingredients providing texture and melting behavior, this includes the starches/gelators/fibre/gums listed in but not limited to the Materials section.
3. Pea protein concentrate (PPC)+starch/gelators/fibers/gums/lipids: this would rely on:
   A proprietary and/or commercial PPC ingredient: to increase the nutritional value and/or provide structuring/functionality characteristics of both protein and starch through physical or chemical methods, with a protein content up to a maximum of 30% protein. These are often less refined ingredient(s) than PPIs, which ultimately lead to less waste.
   A range of commercially available starch/gelators/fibers/gum/lipids ingredients supporting texture and melting behavior. The processing of a PPC retains more of the natural color of the raw ingredient.

In an embodiment, the present invention uses any one of these points (features) or a combination of these points to make the VCAs of the present invention. It should be understood that if one makes a VCA with an emphasis on point 3 (e.g., using the PPC as a compositional ingredient) instead of a PPI as recited in point 2, the VCA would provide less protein content per gram of vegan cheese, so it would have a lower nutritional value, but it would also generate less processing waste (due to the less extensive fractionation involved).
4. Yellow pea flour (YPF)+starch/gelators/fibers/gums/lipids: this would rely on:
   A proprietary YPF ingredient obtained via physical transformation of yellow peas before or post milling, which enhances the technological functionality of the contained macro/micro components. This would provide some increase in the protein content (nutritional value) and would require less of the other ingredients. This could also support texture and melting behavior.
   A range of commercially available starch/gelators/fibers/gum/lipids ingredients supporting texture and melting behavior.

Compared to the approach at point 3, the approach at point 4 could provide VCAs with a protein content equal or lower as compared to point 3, but with the benefit of less process waste production, due to the processing method.
5. A variation of points 1-4+starch/gelators/fibers/gums/lipids+MG
   An MG is used to manipulate the melting characteristics.
6. A variation of points 1-5+inclusions, where an inclusion is a singular or mix of any of the following but not limited to—parsley, thyme, rosemary, chives, oregano, marjoram, salt and pepper, dill, sage, basil, chervil, chilli flakes, paprika, caraway, fennel, turmeric.
7. A variation of points 1-6+inclusions, where an inclusion is a colour which imparts a visual swirl (due to non-homogeneity and mixing method) or a veined cheese type effect.
8. A variation of points 1-7 where a mould, yeast, bacteria or other microorganism is utilised for flavour production or reduction, altering the appearance and/or the texture.
9. A variation of points 1-8 where any mixture of oleosomes, also known as oil bodies, from any below listed sources with or with or without plant-based oils and fats to partially or completely replace fat or oil component in a VCA. It is envisaged that oleosomes are extracted from legumes such as but not limited to peas of all types, lupin, Bambara groundnut, peanuts and other groundnuts, chickpeas, haricot beans, cannellini beans, soybeans and all other types of beans and lentils; oleosomes are also extracted from (a) oilseeds, such as but not limited to sunflower, linseed, canola (rape), pumpkin, and grape, (b) tree nuts such as but not limited to almonds, pecans, and walnuts; (c) cereal bran or germ such as but not limited to rice bran and maize germ; (d) any other plant-based material which contains oleosomes.
10. A variation of points 1-9 where a plant based solid, semi-solid or liquid fat (at room temp) is added and used to impact the VCA textural attribute including the ability to be sliced, its firmness, its crumbliness, its melting ability/quality, etc.

Examples of vegan cheese manufactured using the approach at point 1 can be combined with the approaches of points 2, 3, 4, 5, 6, 7, 8, 9 and 10 to generate the VCAs of the present invention. Moreover, the present invention contemplates using any combination of these approaches together to make VCAs.

In an embodiment, the present invention relates to the manufacture and processing to produce the vegan cheeses using legume-based or legume-derived ingredients. A clear distinction is important to understand how the vegan cheeses of the present invention are made. One way of distinguishing VCAs is to distinguish between legume-based ingredients and legume-derived ingredients:
Legume-based ingredients are products/ingredients such as flours or transformations thereof obtained by adding ingredients without fractionating and separating any compounds from the starting legume flours.
This also includes the physical processing of the pea and/or on the pea flour (or other legume-derived flours) after milling to change its functional behavior and the addition of other ingredients.
Legume-derived ingredients are ingredients obtained by fractionating and separating any compounds from the legume flours, for example pea protein isolate (PPI) obtained via wet fractionation or pea protein concentrate (PPC) obtained from dry fractionation via sieving or air classification. For example, the present invention produced legume related products including but not limited to a pea product enriched in proteins via:
   mechanical disruption and/or extraction including but not limited to jaw crushers, gyratory crushers, roller crushers, roller mills, wheel mills, disc mills, rotary impact mills (hammer mills, pin mills), bar mills, ball mills, jet mills, super mills, micronizers, where particle size reduction is achieved via cutting, crushing, granulation, grinding, spraying, micronization, defibration, and shredding, screw-pressing, blending, cold extrusion, rolling, juicing and pressing.
   aqueous protein extraction methods including but not limited to alkali, acid, salt, reverse micelle, pulsed electric field, ultrasound, high pressure combined with or without a precipitation and/or filtration step.

The present invention relates to the use of the yellow pea as the main legume source. However, it should be understood that other legume-based sources are contemplated such as peas of all types, lupin, Bambara groundnut, peanuts and other groundnuts, chickpeas, haricot beans, cannellini beans, soybeans and all other types of beans and lentils. In an embodiment, the yellow pea is used, and the focus is on three main streams:
1. Development of legume-based ingredients adding food grade acids, lipids, starches, gelling biopolymers, gums, fibers and salts. In an embodiment, the legume-based ingredients will be investigated at a fundamental science level with a view to optimizing the functional properties of a legume flour and/or paste, primarily proteins and starch, and/or to minimize the addition of other ingredients (food grade acids, lipids, starches, gelling biopolymers, gums, fibers and salts). Accordingly, in an embodiment, the present invention contemplates the addition of starches, proteins, and gelling agents.
2. Development of VCA prototypes based on yellow pea (YP). In an embodiment, the present invention relates to a focus on developing cheese analogues using legume-based ingredients and/or legume-derived ingredients. In the former case (i.e., Legume-based ingredients) some of the data generated as part of stream 1 and physical processes have been implemented to modify the flavor and functionality of the YP. In the latter case (i.e., Legume-derived ingredients), PPI was produced in house using an alkaline extraction, for example, to produce vegan-cheeses.
This stream of research has been modified by the use of other ingredients (food grade acids, lipids, starches, gelling biopolymers, gums, fibers, salts and MG) to engineer the meltability of vegan cheese analogues and/or to engineer their texture.
3. Development of vegan-cheeses based on yellow pea (YP) based ingredients in combination with other ingredients such as rice flour. This has focused on developing vegan cheese analogues using Legume-based ingredients (e.g., YP) with rice, potato, tapioca, yam flour, maize starch/flours or fibers helping to structure the product. In some cases, optionally, gelling agents (e.g. gelators) can be added to promote firmness.

Products manufactured as part of streams 2 and 3 were made using food processing units available in the kitchen (e.g., a Thermomix) to demonstrate that products can be produced using conventional kitchen aids. Thus, in one embodiment of the invention, the present invention relates to the use of commonly available kitchen products to produce the VCAs of the present invention. However, scale relevant equipment which delivers the same transformation as the kitchen units are contemplated and considered.

The vegan cheese analogues as shown in the figures herein were prepared over long periods of time and the manufacturers of the various VCAs were not always the same person, so there are some slight variations in the VCAs that may be attributable to the different manufacturers. However, overall, the VCAs as shown in the figures are representative of their appearance and their properties.

### Materials & Methods

### Materials

The following list encompasses an example of the key ingredients that can be used to make the VCAs.
Legume seeds where yellow peas (Pisum sativum) are used as a specific embodiment. The yellow peas should be considered to be in the form of whole (hull on), decorticated (hull removed whole seed) and/or split (hull off, split seed).
Flours produced from legume-based origin with defined particle size distributions.
Flour blends produced from legume-based origins that are mixed to certain proportions based upon starch, protein and/or fibre content.
Bases (alkali)
Organic or inorganic acid
Oils or Fats and their blends (emulsifiers e.g. free fatty acids, monoglycerides, glycerol monostearate, lecithins).
Sodium chloride
Gums and stabilizers
Salt of (but not limited to) organic acids e.g. calcium lactate, potassium chloride, calcium chloride, tricalcium citrate.
Fiber concentrate and isolates of plant-based origin.
Protein concentrates and isolates of plant-based origin.
Modified starch including but not limited to grain, tuber, and legume sources.
Native starch including but not limited to grains, tuber, and legume sources.

### Methods

### Pre-Processing of Legume Seeds

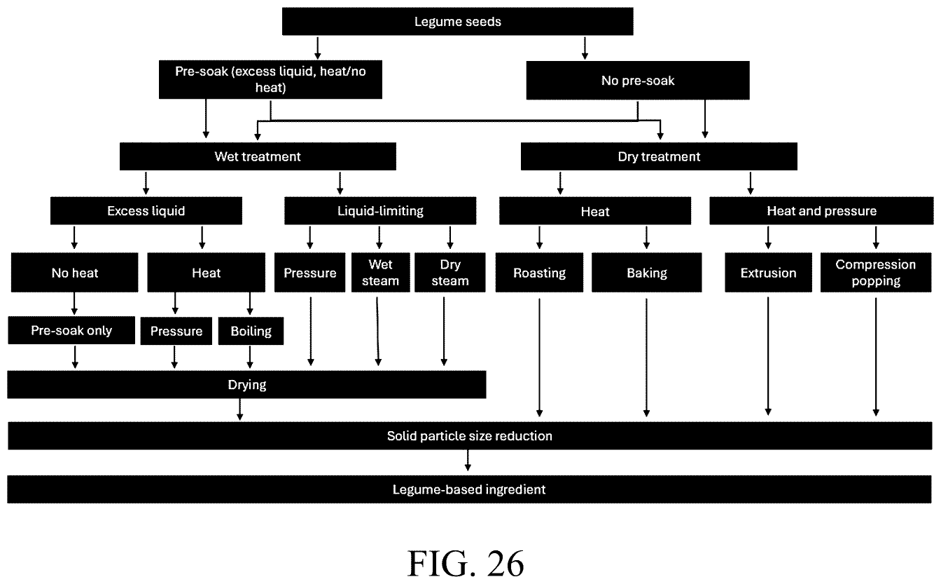

Prior to milling, the seeds of legumes can also be treated in numerous ways (see FIG. 26) to drive physical modifications of the macro and micro components. This can include, but is not limited to, a singular process or the combination of the following:

### Pre-Soaking of Legume Seeds

Legume seed hydration can be achieved through soaking in an excess of solution that can be 100% water based or be a solution that is a mixture of water containing a % of dissolved salt (e.g. alkaline or acid based salts, including but not limited to sodium bicarbonate, sodium acid pyrophosphate). The solution temperature can be between 4° C. up to 80° C. Soaking time can be between 10 mins to 36 hours. Post-soaking seeds can be dried to below 15% (wt. %) water content using drying technologies such as, but not limited to, freeze drying, oven drying, vacuum oven drying, supercritical fluid drying. Alternatively, after soaking, legume seeds can be used directly for VCA manufacture. Alternatively, after soaking, legume seeds can be further processed using technologies such as, but not limited to, moist-heat treatment, e.g. boiling, steaming, or dry-heat treatment, e.g., roasting.

### Pre-Heat Treatment Before Milling

Compression popping is a form of high-temperature short-time (HTST) processing used to create expanded snacks. The process involves compressing the material between two heated platens (range 120° C.-300° C.) under high pressure. This causes starch transformation and the production of superheated water vapor. The applied high temperatures melt the starch and initiate its transition from a semi-crystalline state to a soft rubbery state. Upon release of the popping platens, steam generates air cell formation within the food matrix and the starch cools below the glass transition temperature reaching a glassy state, solidifying into a foam structure. This food foam can be milled into a flour to be used for the manufacture of VCAs.
Boiling is a conventional moist-heat technology. Legume seeds can be boiled in water or in a solution containing one or a mixture of salts for example but not limited to sodium bicarbonate, sodium hydroxide, calcium hydroxide, at different percentage concentrations (0.1-2%). Dry or pre-soaked legume seeds as described above can be boiled for up to one hour. Post-boiling seeds can be dried to below 15% (wwt %) water content using drying. The water removal (drying) can be achieved through methods that include but are not limited to drum drying, spray drying, fluidised bed drying, oven drying, vacuum drying, infrared radiation drying, freeze-drying, microwave drying, vacuum microwave drying, pulsed electric field and radio frequency drying. Drying can also be achieved via a combination approach, wherein any of the technologies listed are combined together to offer additional benefits. Alternatively, after boiling, legume seeds can be used directly for VCA manufacture.
Roasting is a conventional food processing operation involving the use of dry heating. During roasting, hot air covers the raw food to cook it. Legume seeds can be roasted in a convection oven set at temperature between 110 to 250° C. for a time of between about 1 minute to 60 minutes. The same roasting can be achieved using technologies including but not limited to microwave, infrared hot-air, superheated steam, Revtech roaster, and Forced Convection Continuous Tumble (FCCT) roasting and combinations thereof.
Wet Steaming and/or Steaming under pressure and/or super heated steam is a cooking method that uses steam to cook food. On steaming, the goal is to cook gently using the steam produced from boiling water. On steaming under pressure, commonly known as pressure cooking, it involves cooking food using steam under a higher pressure than atmospheric pressure. This method uses a sealed pressure cooker to create a high-pressure environment, which increases the boiling point of water and allows food to cook faster. Superheated steam is steam that has been heated beyond its boiling point at a given pressure, without any liquid water present. This type of steam has higher thermal energy than saturated steam (steam at boiling point) and is typically used in industrial applications due to its higher efficiency and capability. All of these steam technologies allow for preservation of nutrients, colour, and natural flavors but also physically modify macro and micro components of the legumes such as starch, protein, fibre which enables alternative functionality when used to produce VCA's by influencing texture, firmness, melt and stretch.

### Milling of Legume Seeds

The legume seeds (here are between 0.1% to 15% moisture wwb) are mechanically broken down from whole, decorticated or split seeds to a legume flour, this could be achieved through a number of methods including but not limited to jaw crushers, gyratory crushers, roller crushers, roller mills, wheel mills, disc mills, rotary impact mills (hammer mills, pin mills), bar mills, ball mills, jet mills, super mills, micronizers, where particle size reduction is achieved via cutting, crushing, granulation, grinding, spraying, micronization, defibration, and shredding. It should be understood that larger or smaller mean particle sizes than are achieved by the milling or rolling methods disclosed above may be utilized. For example, larger particle sizes can be achieved by cracking, or by a simple chopping procedure and these mean particle sizes may be on the order of <1 μm to 5 mm in diameter, or alternatively, whole, decorticated or split peas may be used. Smaller mean particle sizes may be used. Methods of generating small particle sizes may be attained for example by the rolling or milling methods above combined with air classification technologies, thereby achieving mean particle sizes in the 0.01 μm to 150 μm in diameter range. Other technologies known to those skilled in the art may be used.

In the particular embodiments shown in the Results/Trials section, the milling of the yellow peas was performed on a hammer mill (Perten LabMill 3100, PerkinElmer, Beaconsfield, UK). A feed rate of 200 g/min was used with a rest period of 1 min after 1 min of use to prevent overheating of the material. The milled material produced by milling yellow peas is the material used where the ingredient is otherwise known as pea flour.

### Pressing

Pressing, in one embodiment, can be achieved through hydration of the legume seeds. Hydration can be achieved through soaking in an excess of solution that can be 100% water based or be a solution that is a mixture of water containing a percentage (0.1-5%) of dissolved salt (e.g. alkaline or acid based salts, including but not limited to sodium bicarbonate, sodium acid pyrophosphate). The soaking time can be between 10 mins to 36 hours at temperature between the temperature in a refrigerator (4° C.) up to about 60° C.

The percentage increase in weight through hydration can be from 10-175%, or 50-150%, or 75-135%, or 100-135%. The legume seeds may then be pressed or juiced mechanically, which may be achieved through methods such as screw-pressing, blending, cold extrusion, juicing and pressing. Other methodologies are contemplated. These methods can be split into two or more fractions either as part of the pressing/juicing process or by separation through a further process such as but not limited to centrifugation, filtration or sedimentation.

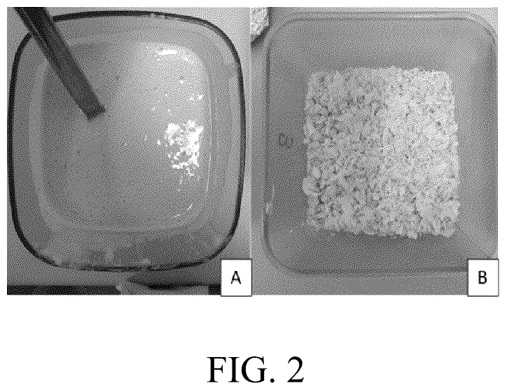

In the particular embodiments shown in the Results/Trials section, yellow peas were soaked overnight in water at 4° C., drained and washed with more water and drained again. The soaked yellow peas were pressed through a screw juicer (Angel 8500s, Angel Juicers, Naarden, Netherlands) collecting a “liquid fraction” hereinafter also referred to as the cream fraction and a solid fraction hereinafter also referenced as the “solids fraction”. These two fractions are shown in FIG. 2.

### Protein Extraction/Concentration

To extract and concentrate the protein from the legume seeds a protein extraction process is employed either though dry methods such as but not limited to dry fractionation or aqueous protein extraction methods including but not limited to alkali, acid, organic acid, inorganic acid, salts, reverse micelle, pulsed electric field, electrostatic phase (electric) separation, ultrasound, high pressure combined with or without a precipitation and/or filtration step to produce legume-derived protein concentrate or legume-derived isolate.

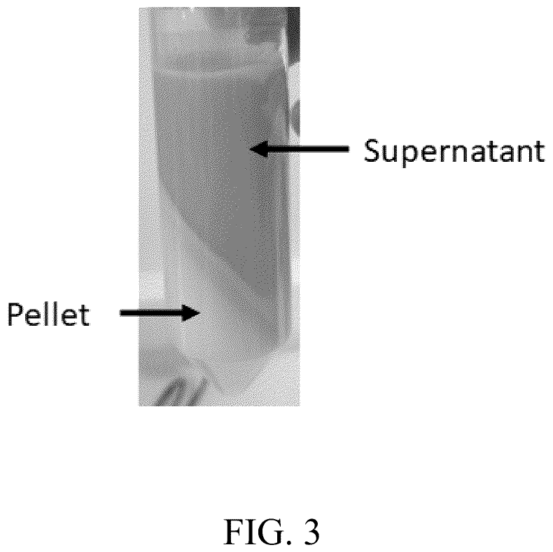

In the particular embodiments shown in the Results/Trials section, the yellow pea flour, an alkaline extraction process was used. Pea flour was dispersed in deionized water at a ratio of 1:3 and adjusted to pH 7-14 with 1 M NaOH and stirred at 20-85° C. for a minimum of 1 minutes in a heated blender (Thermomix Vorwork, Wuppertal, Germany) running in reverse mode to minimize material shear. Alternatively, a pH range of 7-13, or 8-12, or 8-11, or 8-10 should be used with an alternative temperature range of 25-75° C., or 30-70° C., or 35-65° C., or 40-60° C., or 50-60° C. or 50° C. The pea flour dispersion was centrifuged until a pellet is achieved and the protein rich supernatant was separated from the starch and fiber rich pellet as shown in FIG. 3. The supernatant was adjusted to pH 5.5-7.5, or pH 6.0-7.0, or pH 6.6 with food grade hydrochloric acid before use or before drying.

### Drying

Water is removed from the materials to allow for the addition of ingredients without adding additional water. The water removal (drying) can be achieved through methods that include but are not limited to drum drying, spray drying, fluidised bed drying, oven drying, vacuum drying, infrared radiation drying, freeze-drying, microwave drying, vacuum microwave drying, pulsed electric field and radio frequency drying. Drying can also be achieved via a combination approach, wherein any of the technologies listed are combined together to offer additional benefits such as less nutrient destruction, cellular material conservation, enhanced functionality, and/or improved process efficiency. Such examples would include oven drying with a pulsed electric field, oven drying with microwave drying, fluidized bed drying with radio frequency drying and other possible methodologies.

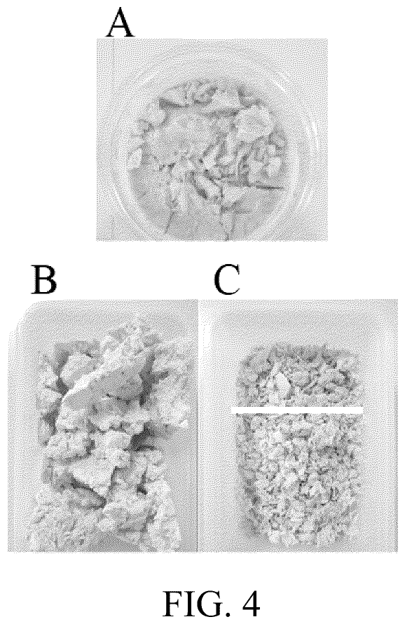

In the embodiments shown in the Results/Trials section, the supernatant and pellet from the pH shift extraction, and the screw-pressed solids were frozen at −80° C. overnight, and then freeze-dried (Lablyo, Frozen in Time, York, United Kingdom) to a constant mass and stored at 20° C. in an airtight box. The freeze-dried material is shown before milling in FIG. 4 with (A) representing the freeze-dried pH shift supernatant, (B) representing the pH shift pellet, and (C) representing the screw pressed solids. These various freeze-dried components/fractions were then saved for milling.

### Milling of Fractions

The produced legume seed fractions after drying are mechanically broken down from the larger particles, blocks or flakes to achieve a powdered form, this could be a number of methods including but not limited to jaw crushers, gyratory crushers, roller crushers, roller mills, wheel mills, disc mills, rotary impact mills (hammer mills, pin mills), bar mills, ball mills, jet mills, super mills, micronizers, where particle size reduction is achieved via cutting, crushing, granulation, grinding, spraying, micronization, defibration, and shredding.

In the particular embodiments shown in the Results/Trials section, the milling of the freeze-dried pH shift pellet and the freeze-dried screw pressed fraction solids produced above was performed as described above (e.g., using a Perten LabMill 3100, PerkinElmer, Beaconsfield, UK hammer mill with a feed rate of 200 g/min with a rest period of 1 min after 1 min of use to prevent overheating of the material). These dry mixes were then saved for manufacturing the vegan cheese analogues.

### Impact or Pre-Processing:

As highlighted above, legume seeds can be treated to drive physical modification of macro and micro components and therefore change the properties of the flour itself. When the properties of the flour is modified, this impact the production of VCA's and therefore, it also affects the VCA product characteristics. In an embodiment, the characteristics of the VCA can be measured by (but not limited to) microscopy: both brightfield and cross polarized, x-ray diffraction, rapid viscoanalyzer, textural analysis (TAX-2T), and differential scanning calorimetry (DSC). The afore mentioned techniques can be used to measure a number of characteristics including the number of intact cells after milling, the starch granule integrity, the starch crystallinity, flour only formulation peak viscosity, flour only formulation final viscosity, flour only formulation gel hardness, VCA peak viscosity, VCA final viscosity and/or VCA gel hardness. For the flour only formulations, viscosities can range from very low (<300 cp) to very high (>1500, cp). In VCA formulations, the viscosity can range from very low (<1000 cp) to very high (>4000 cp), the hardness can range from very low (<300 g) to very high (>30000 g).

### Manufacturing Vegan Cheeses

The vegan cheese analogues (VCAs) were produced by producing a mix of dry ingredients and by combining the powders or other dry formats, hydrating the dry mix, heating the hydrated material while mixing at temperatures from 60° C. to 100° C. and providing shearing rates of between 30 rpm to 25 000 rpm. Lipids can be added at either the start of the processing or during the process. Other lipids, including but not limited to palm oil, palm kernel oil, cocoa butter, shea butter and shea stearin can be used at levels from 0% to 50%. In one embodiment, the hydration and the heat processing steps are one and the same step. The heat processed mix is poured into a mold, cooled and stored at refrigeration temperatures. The cooling time to between 0° C. to 8° C. can be completed as rapidly as possible or up to a maximum time where any part of the VCA spends no more than 90 min in the temperature range of 63° C. to 8° C. Once the temperature is stabilized, the VCA is maintained at a temperature of 0-8° C. for a time period of 1-20 days. The particular embodiment detailed below is using kitchen scale equipment, the production of the VCA is in no way limited to the specific equipment used in the listed embodiments, the use of commercial and scale relevant equipment is envisaged.

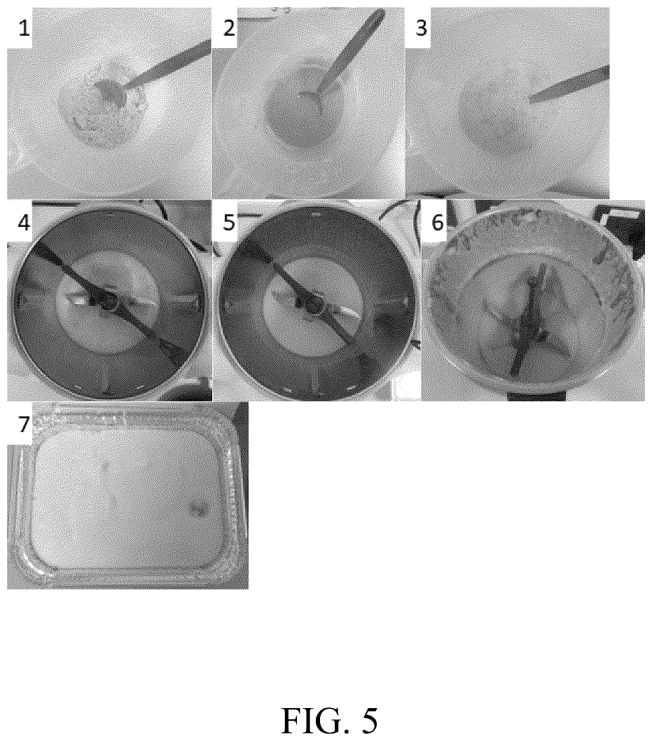

In the particular embodiments shown in the Results/Trials section, the VCAs were produced to a total mass of 353 g of which 15% (53 g) was comprised of coconut oil. The remaining 300 g of material, known forthwith as the aqueous phase (AP), comprised all other ingredients, proportions of which were varied relative to the aqueous phase, not the total mass. A visual overview of the VCA production process is given in FIG. 5 wherein the process was as follows.

The VCAs were produced by combining all the dry ingredients: pea flour, starches, hydrocolloids, and acids and mixing dry to a homogeneous mixture (see 1 in FIG. 5). A small amount of the aqueous solution, either 0.15 M sodium chloride solution or protein rich supernatant, was added to create a uniform viscous paste (see inset 2 in FIG. 5) after which the remaining aqueous solution was added and stirred to create a dispersion (see inset 3 in FIG. 5). The dispersion pre-mix was poured into a heated blender (Thermomix, Vorwork, Wuppertal, Germany) (see inset 4 in FIG. 5). The pre-mix was stirred in reverse at speed setting one with the beater attachment for 30 min at 50° C. (see inset 5 in FIG. 5). The temperature was increased to 80° C., the speed was increased to 3.5 (see inset 6 in FIG. 5). The coconut oil was melted but kept below 80° C. and added slowly while mixing at speed 3.5 immediately when 80° C. was reached (see inset 6 in FIG. 5). The heat processed material was poured into a small aluminum tray and allowed to cool at 4° C. (see inset 7 in FIG. 5).

### Moisture Content of Vegan Cheeses

The moisture content can be measured through a number of means including but not limited to gravimetric methods such as oven drying, vacuum oven drying and thermogravimetric analysis, chemical methods such as Karl Fischer titration, optical methods such as infrared spectroscopy, dielectric methods such as electrical conductivity, hydrogen nuclear magnetic resonance and/or equilibrium relative humidity.

In the particular embodiments shown in the Results/Trials section, the moisture content of the prepared VCAs were measured by accurately weighing approximately 5 g of material into an aluminum tray or 5 cm diameter and placing the VCA in a 105° C. oven for 24 hours before weighing the dry weight. The moisture content of the sample was calculated on a wet weight basis according to the ratio shown in Equation 1:

Moisture content (%) ((Initial mass pre oven drying MINUS final mass post overnight drying) DIVIDE (Initial mass pre-oven drying)) MULTIPLIED by 100 (Eq. 1)

### Melting Test

VCA melting can be measured by the Schreiber method, Arnott method and tube methods or instrumental methods such as but not limited to rapid viscoanalyzer, other rheological methods, microscopic methods, spectroscopic methods and differential scanning calorimetry.

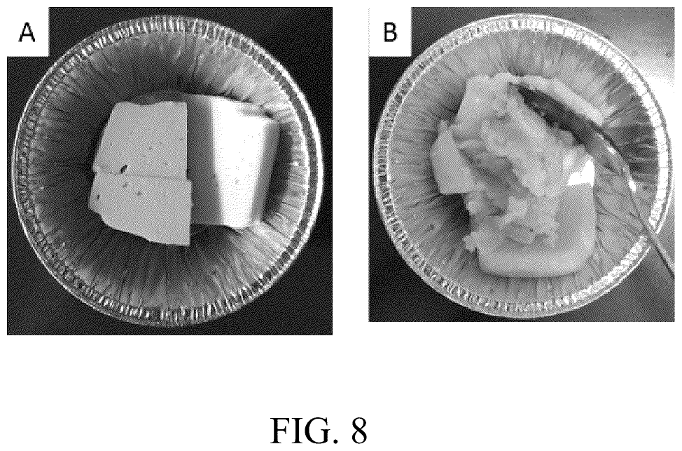

In the majority of the particular embodiments shown in the Results/Trials section a qualitative melting test method was employed, to test the properties of the VCA on heating, approximately 16 g of the VCA was weighed into a circular aluminum tray. The VCA sample was placed in an oven at 150° C. for 5 min, observing visually for softening, flow and stretch. The VCA sample was placed in the oven for another 10 min at 150° C. and visual observation recorded a second time. The meltability of the various VCAs are shown in FIGS. 8, 10, 12, 14, 16, 18, 20, 21 and 22.

In some of the embodiments in the Results/Trials section a qualitative melting method was employed as follows: a disc of VCA was cut 41 mm in diameter and 0.48 mm thick and chilled at 4° C. for 30 min. The sample was placed in an oven at 232° C. for 5 min and the spread of the VCA was assessed qualitatively.

### Texture Analysis

The hardness of the cheeses were estimated using a compression test, other analyses which could be used are but not limited to puncture tests involving a variety of probes, and other compression tests with differing probe dimensions forces and timings.

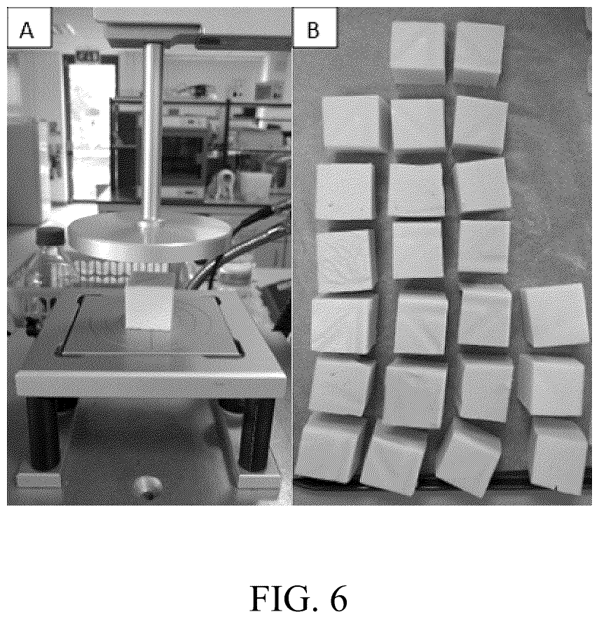

In the particular embodiments shown in the Results/Trials section, the VCAs were cut into 3 cm cubes for texture analysis shown in FIG. 6B. The hardness of a select number of the VCAs produced was analyzed with a texture analyzer (TA-HD plus, Stable Micro Systems, Godalming, Surrey, UK) with Exponent software (Version 6,1,22,0. The texture analyzer was fitted with a p/100 aluminum 100 mm diameter plate probe and a heavy-duty platform and a 5 kg load cell, as shown in FIG. 6A. The texture analyzer was used in compression with the pre-test speed set to 0.5 cm/sec, with a trigger force of 5.0 g, a test speed 0.05 cm/sec and a strain of 70%. The peak force, distance travelled, and peak negative force were recorded.

### Results/Trials

### Pea Flour Vegan Cheese Alternative

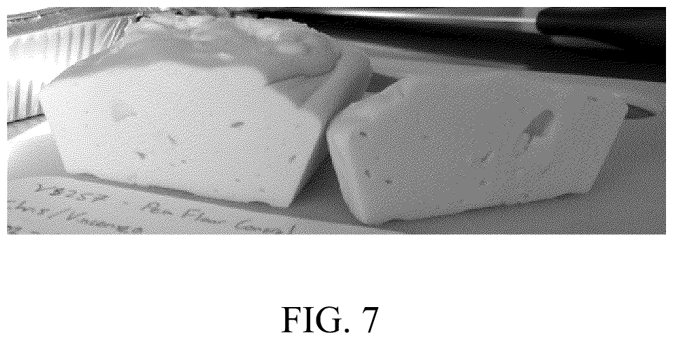

A VCA was produced by the composition given in Table 1 to assess the properties a VCA produced from pea flour. The pea flour produces a VCA with homogeneous texture with gas bubbles with firm gel structure as shown in FIG. 7. However, the pea flour VCA showed a softening after 15 min at 150° C. but did not completely melt as shown in FIG. 8B. The pea flour VCA although suitable in terms of textural properties does not produce the ideal melting properties.

Thus, in an embodiment, the present invention relates to the product and methods of producing a VCA that comprises pea flour. The following Table 1 illustrates a compositional make-up of a typical pea flour based VCA in accordance with the present invention.

TABLE 1
Composition of pea flour based VCA.

| | Percentage |
|---|---|
| Ingredient | Mass (%) |
| 0.15M Sodium chloride solution | 40-97 |
| Pea flour | 3-50 |
| Coconut oil | 0-50 |
| κ-carrageenan | 0-1.5 |
| Lactic Acid | 0-3 |

### Yellow Pea Flour Component Trials

In order to determine which components of the yellow pea flour are responsible for impeding melting, tests were performed to change the formulations and assess the impact of these formulation differences. A typical pea flour compositional make-up is shown in table 2 below.

TABLE 2
The proximal composition of yellow pea flour except for protein which
was estimated from nitrogen content (conversion factor 6.25).

| | Estimated |
|---|---|
| Component | Proportion (%) |
| Protein | 26 |
| Starch | 43 |
| Fibre | 14 |
| Ash | 2 |
| Moisture | 9 |

Model VCAs were produced wherein the composition was adjusted to give the same proportion of the individual components, protein, starch, or fibre as would be present in the pea flour VCA from Table 2. Yellow pea flour is composed of on average of 26% protein, 43% starch, 14% fibre, 2% fat and 9% moisture although this will vary depending on the growth conditions as well as the pea cultivar and different compositional amounts can be attained by varying these conditions.

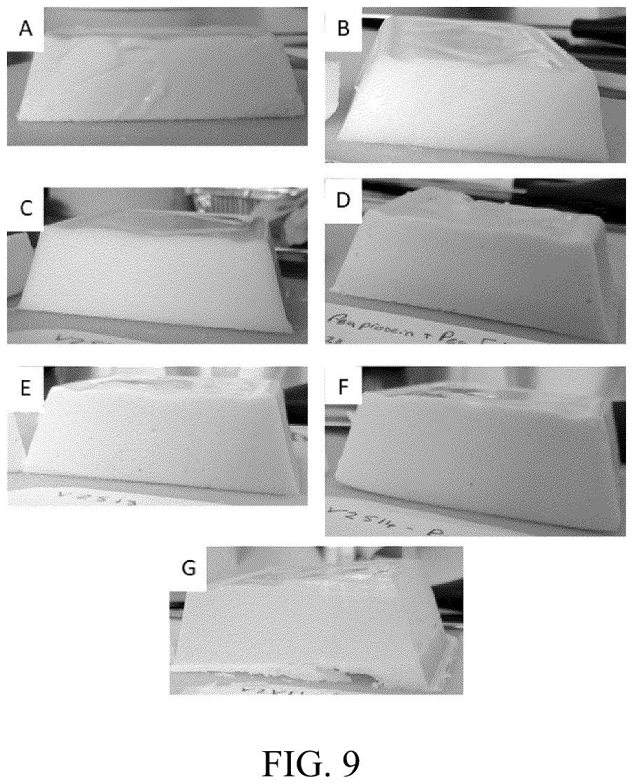

Any difference in mass from those in Table 2 were compensated by adding an aqueous sodium chloride solution. The VCAs produced were with 0.15 M sodium chloride solution, 1% x-carrageenan of the aqueous phase (AP), 0.4% lactic acid in the AP and 15% coconut oil. A unique VCA was produced with each of the following yellow pea components added in the following proportions (in the AP): A) 4.4% pea protein; B) 8% pea starch; C) 2.7% pea fibre; D) 4.4% pea protein concentrate with 2.7% pea fibre; E) 4.4% pea protein concentrate, 8% pea starch and 2.7% pea fibre; F) 4.4% pea protein concentrate, 8% potato starch and 2.7% pea fibre; and a G) control gel with no added protein, starch or fibre, all shown in FIG. 9. All of the VCAs from individual components shown in FIG. 9 produced a cohesive gel structure, with all components improving the oil incorporation relative to the control which showed clear phase separation (see G in FIG. 9). The pea starch VCA (FIG. 9B) exhibited a coconut oil layer on the surface and a visible heterogeneous gel suggesting that the two phases did not completely mix.

None of the pea protein VCA FIG. 9A, pea fibre VCA FIG. 9C or the pea protein and pea fibre VCA FIG. 9D showed any evidence of phase separation or surface oil. These results demonstrate that either the pea protein or the pea fibre allow for oil incorporation in the VCA with the showing that a combination of both the pea protein and the pea fibre combined give a good homogenous product. The pea protein VCA in FIG. 9A showed a reduction in hardness relative to the control x-carrageenan gel in FIG. 9G whereas both the pea starch VCA in FIG. 9B and the pea fibre VCA in FIG. 9C increased hardness. The pea protein, pea fibre and potato starch VCA in FIG. 9E and the pea protein, pea fibre and pea starch VCA in FIG. 9F are both evidence that the addition of non-yellow pea starch at the level of 8% of the AP do not inhibit gelation and produce comparably hard gels relative to VCAs prepared in the absence of starch.

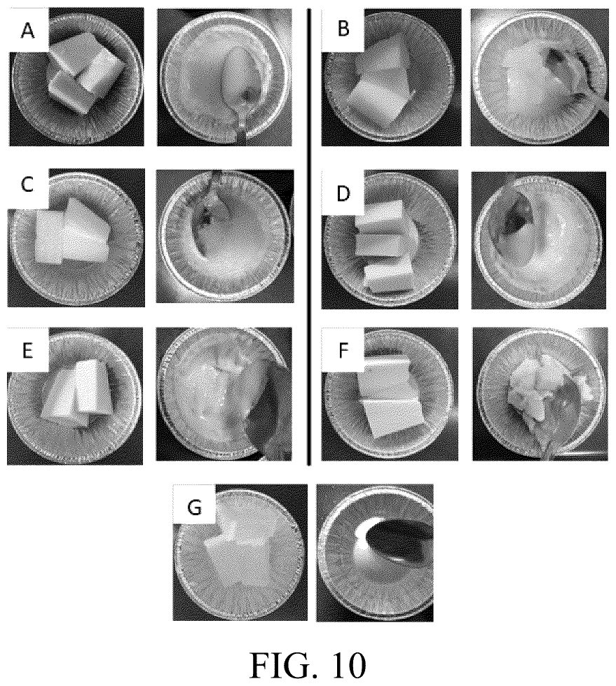

The melting test images in FIG. 10 show the same cheeses as shown in FIG. 9 but show how they melt. It should be noted that the carrageenan gel control (FIG. 10G) in the absence of other components melts to a low viscosity liquid. The pea protein, pea fibre, pea protein and pea fibre combination, and pea protein with pea fibre and potato starch shown in FIGS. 10 (A), (C), (D) and (E), respectively do not prevent melting but alter the viscosity, viscoelastic and coating properties of the resulting melt. The two VCAs containing pea starch in FIGS. 10 (B) and (F) soften but did not melt suggesting that pea starch to some extent inhibits melting in VCAs. Furthermore, the pea protein, pea fibre and potato starch VCA in FIG. 10E show that a VCA can be produced with pea protein, pea fibre and an added starch which melts on heating.

Pea Flour Level which Inhibits Melting

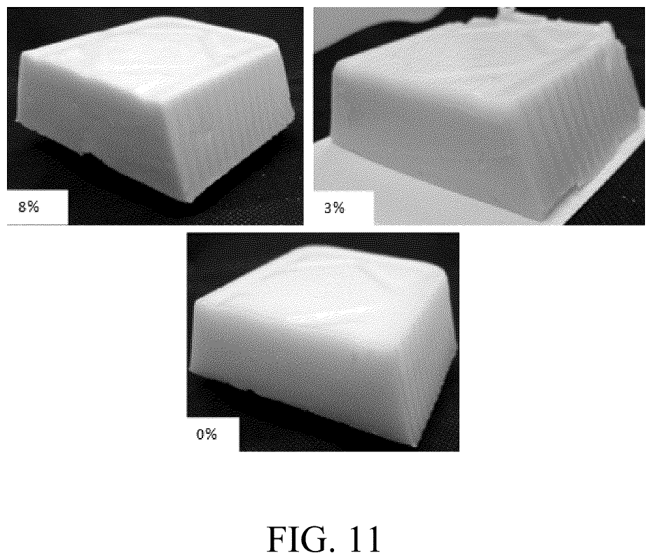

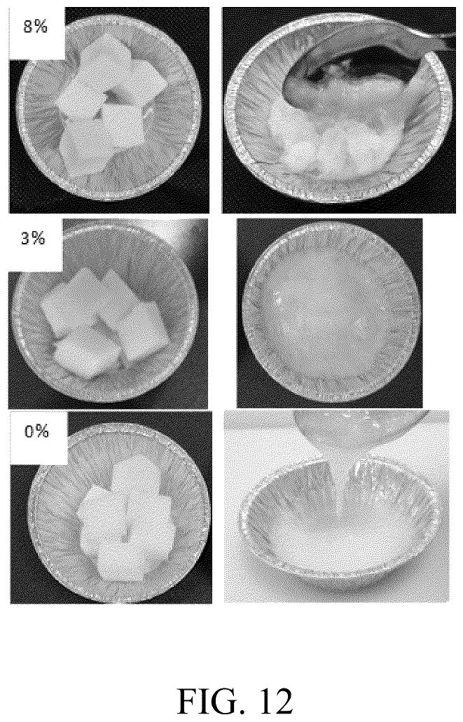

From previous trials, the level of pea flour which inhibits melting can be inferred. It was previously shown in FIG. 7 that pea flour at 19% of the AP (or 16% of the total mass) inhibits melting. A VCA with 8% of AP pea flour to the composition listed in Table 3 was produced. FIG. 11 shows that the 8% pea flour VCA was visually uniform in structure, cohesive and of a pale-yellow cheese like color. The 8% pea flour VCA is compared to a 3% pea flour VCA of composition in Table 4 and 0% pea flour VCA of composition in Table 5 in which pea flour and potato starch totalled 20% of the AP in all three VCAs. The x-carrageenan content of the 3% pea flour VCA was 0.25%, which differs from the 1% found in the 8% and 0% VCAs. The lower x-carrageenan content of the 3% pea flour VCA had noticeably lower hardness but both 3% and 0% pea flour VCAs produced a cheese like material. The 0% and 3% pea flour VCAs showed evidence of melting while the 8% pea flour softened to a paste which could not be described as fully melted, as shown in FIG. 12. The melting test results suggest the proportion of pea flour in a VCA which does not inhibit melting is above 3% of AP but below 8% of AP.

TABLE 3
Composition of 8% pea flour VCA.

| | Percentage |
|---|---|
| Ingredient | Mass (%) |
| 0.15M NaCl | 40-92 |
| Pea Flour | 8 |
| Potato Starch | 0-50 |
| Coconut oil | 0-50 |
| κ-carrageenan | 0-1.5 |
| Lactic Acid | 0-3 |

TABLE 4
Composition of 3% pea flour VCA.

| | Percentage |
|---|---|
| Ingredient | Mass (%) |
| 0.15M NaCl | 40-97 |
| Pea Flour | 3 |
| Potato Starch | 0-50 |
| Coconut oil | 0-50 |
| κ-carrageenan | 0-1.5 |
| Potassium chloride | 0-3 |
| Lactic Acid | 0-3 |

TABLE 5
Composition of 0% pea flour VCA.

| | Percentage |
|---|---|
| Ingredient | Mass (%) |
| 0.15M NaCl | 40-99 |
| Pea Flour | 0 |
| Potato Starch | 0-50 |
| Coconut oil | 0-50 |
| κ-carrageenan | 0-1.5 |
| Lactic Acid | 0-3 |

### Impact of Lipid Content (Coconut Oil % Total Mass), Stabilization Time (Across 15 Days) on VCA Hardness (g)

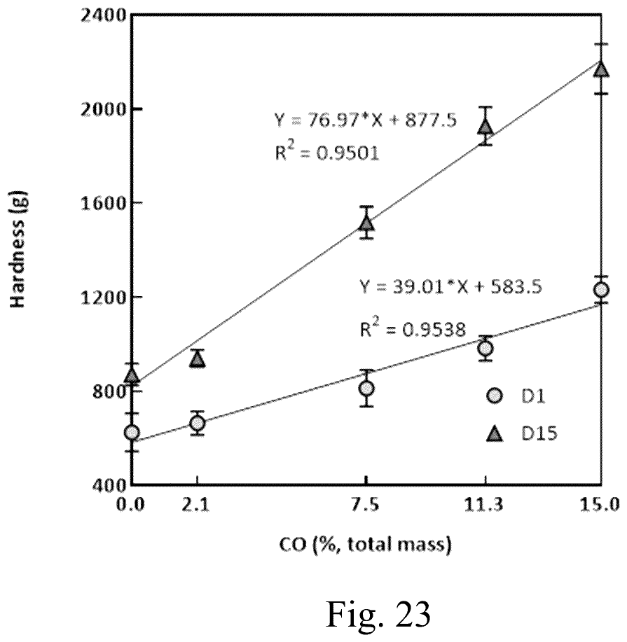

Firmness is shown to increase in correlation with an increase in fat in the various formulations. Firmness also increases across the stabilization period (across 15 days) see FIG. 23. D1 is the various formulations at day 1 and D15 is the various formulations at day 15. This indicates that using higher concentrations of coconut oil and employing a waiting period will increase the hardness of the vegan cheese.

### Impact of Lipid Type (Coconut Oil/Rapeseed Oil Ratio Based on 15% Total Lipid Content) and Stabilization Time (Across 15 Days) on VCA Hardness (g)

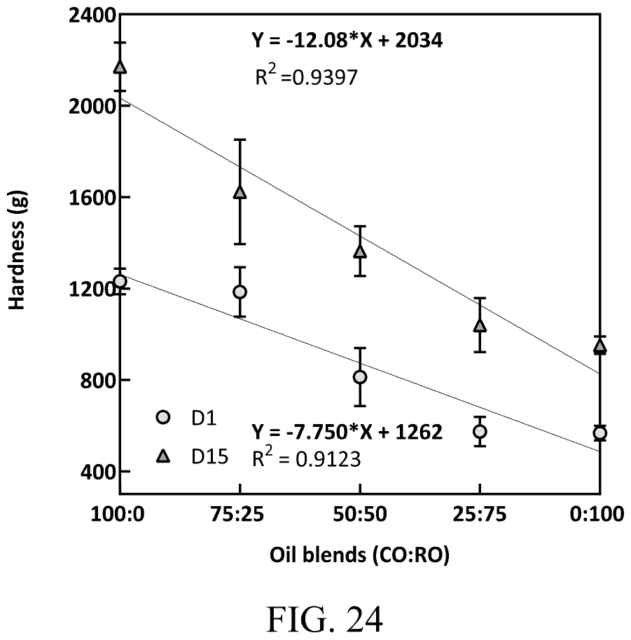

Oil types and ratio of a blend can be used as a lever to reduce hardness. Where, VCA firmness decreases with increasing ratio of liquid oil (here Rapeseed oil (RO) to solid fat (here Coconut Oil (CO)). The correlation is still also present with stabilization time (here across 15 days) which indicates that the VCA matrix is also somewhat independent to the type of fat used see FIG. 24. Thus, to reduce hardness, one should increase the percentage of rapeseed oil relative to the amount of coconut oil. These results are seen irrespective of the amount of time that the vegan cheese is processed.

### Impact of GMS Content (% Total Flour) on VCA Hardness (g)

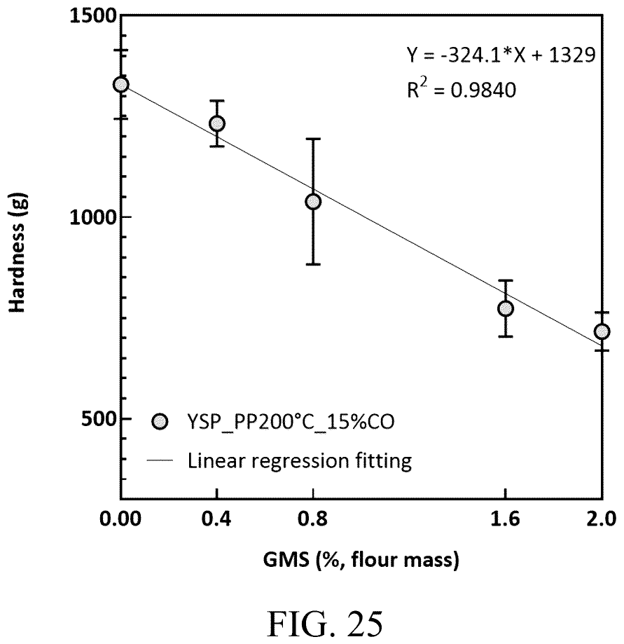

Emulsifiers such as MG can be used to enhance meltability of legume-based VCAs but can also be used to modulate the VCA firmness. GMS is an example of an MG. In the embodiment shown in FIG. 25, the legume flour is compression popped at 200° C. pea flour and the MG is GMS. It can be seen that the VCA hardness decreases as the GMS content increases as a percentage of the flour content. See FIG. 25.

### Screw-Pressed Pea Vegan Cheese Analogue

VCAs were produced from both the screw-pressed cream fraction and the screw-pressed solids fraction to test if a mechanical fractionation method could produce a VCA with sufficient gel strength and improve melting properties. The composition of the screw-pressed cream fraction VCA is given in Table 6. The screw-pressed cream fraction was not dried and had a moisture content of 54.5 (±0.1) % so the mass of cream fraction was increased to 120.00 g and 175.75 g of the 0.15 M aqueous NaCl was added (which was a decrease relative to the amounts added in the compositions of Tables 3-5). The VCA produced with screw-pressed solids composition is detailed in Table 7. The screw-pressed solids had moisture content 35.7 (±1.0) % but due to the high viscosity of the premix created with the 0.15 M sodium chloride solution, the mass of screw-pressed solids added was 60.00 g meaning the dry mass is a lower amount than the pea flour VCA from Table 1.

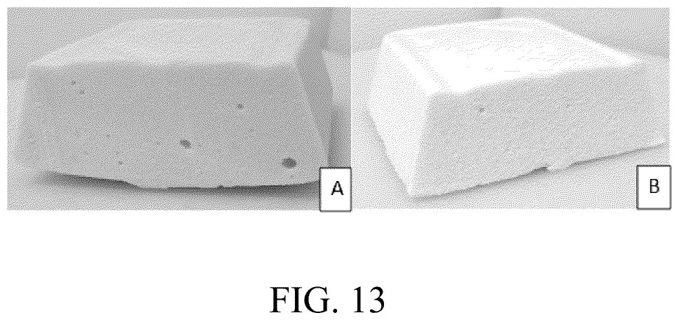

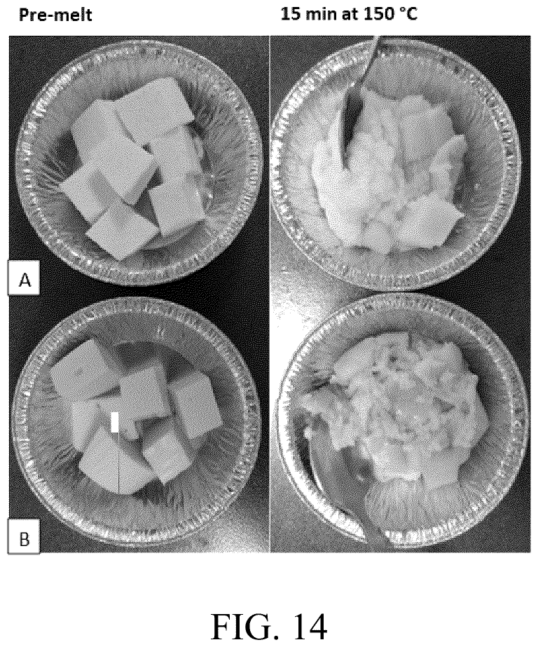

Both the screw-pressed cream and solid fractions produced VCAs, shown in FIG. 13, possessed a similar hardness to the 19% pea flour by AP VCA shown in FIG. 6 and no visible oil phase separation was seen in either VCA. Visually, the screw-pressed cream fraction produced a pale yellow VCA, whereas the solids produced an off-white VCA. Neither the screw-pressed cream fraction nor the solids fraction VCA produced a VCA which melted upon heating, but both VCAs softened to a viscous paste as shown in FIG. 14. These results show that the screw-pressed solids can be used to produce a white non-meltable VCA. The mechanical screw-pressed yellow pea fractions generally are not suitable for producing a meltable VCA without further processing, but can produce a VCA, which is not meltable.

TABLE 6
Composition of screw-pressed cream fraction VCA

| | Percentage |
|---|---|
| Ingredient | Mass (%) |
| 0.15M NaCl | 0-99 |
| Screw-pressed cream fraction | 1-100 |
| Coconut oil | 0-50 |
| κ-carrageenan | 0-1.5 |
| Lactic Acid | 0-3 |

TABLE 7
Composition of screw-pressed solids fraction VCA

| | Percentage |
|---|---|
| Ingredient | Mass (%) |
| 0.15M NaCl | 40-97 |
| Screw Pressed Solid Fraction | 3-60 |
| Coconut oil | 0-50 |
| κ-carrageenan | 0-1.5 |
| Lactic Acid | 0-3 |

### pH Shift Protein Extraction

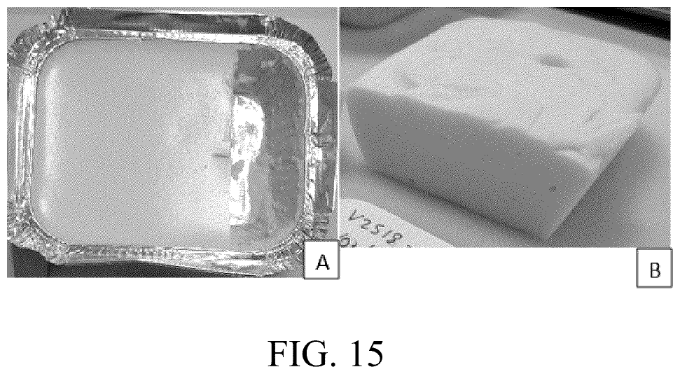

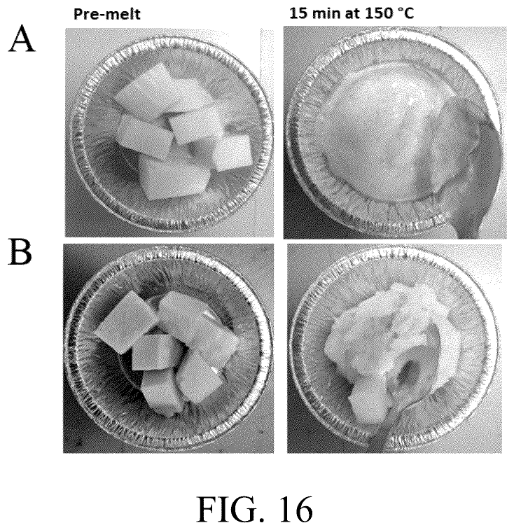

Subsequently, experiments were performed to determine if the pea starch can be extracted from the yellow pea flour and the protein used to produce a VCA which is meltable on heating. Several VCAs were produced with the pH shift extraction supernatant without drying with the composition of one VCA enumerated in Table 8 and the pH shift pellet composition enumerated in Table 9. The pH shift supernatant produced a low hardness VCA with no visible oil separation to produce a pale-yellow dairy cheese-like color as demonstrated in FIG. 15A. The pH shift pellet produces a firm higher hardness VCA similar to the 19% pea flour VCA shown in FIG. 6 with an off-white color and no visible oil separation as is shown in FIG. 15A. The pH shift supernatant does not inhibit melting on heating, which is shown in FIG. 16A, with the VCAs melting to a low viscosity liquid. However, the pH shift extraction pellet inhibits melting producing a high viscosity paste on heating as is shown in FIG. 16B. In the case of the supernatant, the pH shift extraction process removes sufficient starch to allow melting of a VCA while maintaining the yellow color. Accordingly, in an embodiment, the present invention relates to VCAs that have this yellowish color with the VCA having much of the starch removed.

TABLE 8
Composition of pH shift supernatant VCA

| | Percentage |
|---|---|
| Ingredient | Mass (%) |
| Water | 0-98 |
| pH Shift Supernatant | 1-100 |
| Coconut oil | 0-50 |
| κ-carrageenan | 0-1.5 |
| Lactic Acid | 0-3 |

TABLE 9
Composition of pH shift pellet VCA

| | Percentage |
|---|---|
| Ingredient | Mass (%) |
| RO Water | 0-98 |
| pH Shift pellet (Wet) | 1-100 |
| Coconut oil | 0-50 |
| κ-carrageenan | 0-1.5 |
| Lactic Acid | 0-3 |

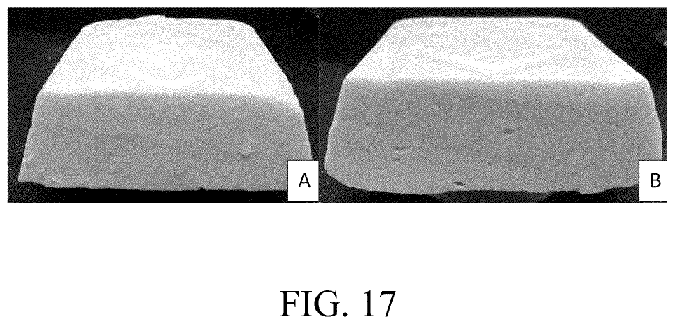

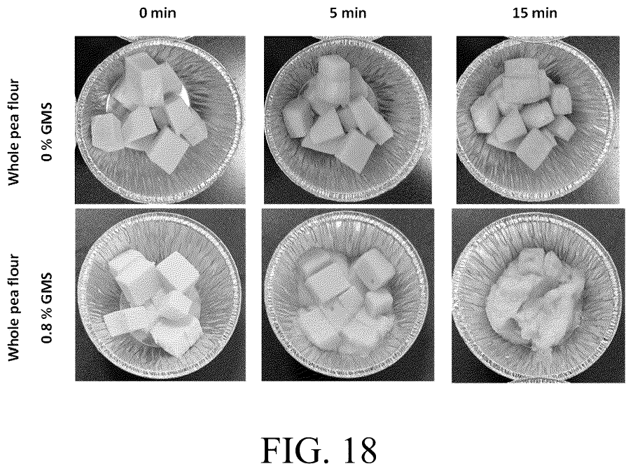

In subsequent experiments, Glycerol monostearate, referred to henceforth as GMS, was added to some of the VCAs of the present invention and Tables 10-12 represent a comparison of the compositional formulations of these various cheeses with and without GMS. FIGS. 17-18 show how the addition of GMS affected the properties of these various VCAs. For example, the efficacy of GMS in improving the melting properties of pea flour VCA was evaluated, which is shown in FIG. 18.

The addition of GMS to the whole flour gives increased softening on heating and improves the flow but still does not readily flow, melting to a paste as shown in FIG. 18.

The addition of GMS improves the melting properties of the VCAs and it gets closer to replicating dairy cheese melting properties when used with pea flour VCA relative to other available vegan cheeses.

Moreover, experiments were performed to determine if the removal of the residual 2% yellow pea flour improved the melting properties of the VCA made with yellow pea protein extract.

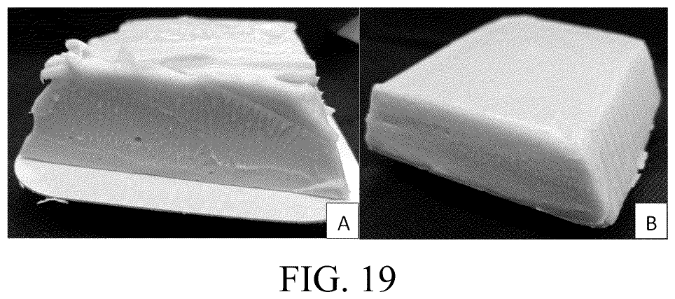

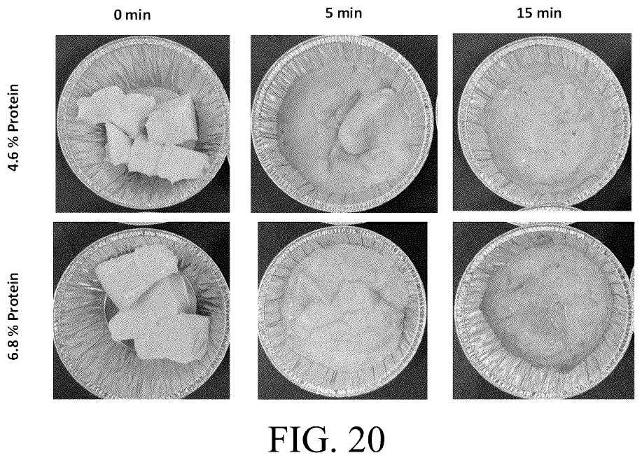

Furthermore, a VCA was tested that was produced with about 7% (e.g., 6.8%) protein from yellow pea flour extract. This VCA was tested against a 4.6% protein content VCA to ascertain how they appeared both prior to and after an attempt at melting (see FIGS. 19 and 20). Two VCAs with 5.8% and 8.5% yellow pea protein extract, 4.6% and 6.8% protein, by total mass were produced without any added pea flour to assess if the melting properties were improved by removing the pea flour. The results of these melting experiments of these VCAs are shown in FIG. 20. The VCA with 4.6% exhibited a soft gel strength and sticky surface whereas the 6.8% protein VCA showed a firmer but still soft gel strength and a surface reduced in stickiness relative to the 4.6% protein VCA. Previous trials with 2% pea flour and 4.6% protein produced VCA with a firmer gel strength and reduced the surface stickiness relative to both VCAs produced here without the pea flour.

The melting properties of the 4.6% protein VCA and the 6.8% protein VCA are shown in FIG. 20. Both VCAs produce a viscous liquid on heating for 5 minutes, which further melts and shows some browning after 15 minutes. Previous trials performed by the inventors with 2% pea flour and 4.6% protein showed softening and produced a viscous paste on heating. Therefore, these melting properties could be considered an improvement that is similar to melted dairy cheddar cheese in both flow and melting.

TABLE 10
Composition of a VCA with a GMS containing Pea
Flour: pea flour VCA with 0.8% (by weight) GMS.

| | Percentage |
|---|---|
| Ingredient | Mass (%) |
| 0.15M Sodium chloride solution | 40-95 |
| Pea flour | 3-50 |
| Coconut oil | 0-50 |
| GMS | 0.8 |
| κ-carrageenan | 0-1.5 |
| Lactic Acid | 0-3 |

TABLE 11
shows the compositional formulation of a VCA that is
comparable to the composition of VCA in Table 10 except
that the VCA in Table 11 does not contain any GMS.

| | Percentage |
|---|---|
| Ingredient | Mass (%) |
| 0.15M Sodium chloride solution | 40-97 |
| Pea flour | 3-50 |
| Coconut oil | 0-50 |
| GMS | 0 |
| κ-carrageenan | 0-1.5 |
| Lactic Acid | 0-3 |

TABLE 12
12 and 13 show the compositional formulation of Vegan
Cheeses based on Yellow Pea Protein Extract with estimated
protein concentration of 4.6 w/w % and 6.8 w/w %.

| | Percentage |
|---|---|
| Ingredient | Mass (%) |
| 0.15M Sodium chloride solution | 30-98 |
| Potato starch | 0-50 |
| Pea protein extract | 4.6-70 |
| Coconut oil | 0-50 |
| κ-carrageenan | 0-1.5 |
| Lactic Acid | 0-3 |
| Nutritional yeast | 0-15 |
| White miso | 0-5 |

TABLE 13

| | Percentage |
|---|---|
| Ingredient | Mass (%) |
| 0.15M Sodium chloride solution | 30-98 |
| Potato starch | 0-50 |
| Pea protein extract | 6.8-70 |
| Coconut oil | 0-50 |
| κ-carrageenan | 0-1.5 |
| Lactic Acid | 0-3 |
| Nutritional yeast | 0-15 |
| White miso | 0-5 |

Removing the pea flour from the yellow pea protein extract VCA improves melting properties but to some extent can be detrimental to textural properties.

To assess the effect of pea flour content independent of other components, VCAs were produced with a range of pea flour contents (0% to 18%) with the VCAs made up to the same total final mass by proportionally increasing the mass of the other components, GMS was added at a range of concentrations with no adjustment of mass resulting in small variations in final mass of the VCAs. The ranges at which the ingredients were trialed is shown in Table 14.

TABLE 14

| Ingredient | Percentage Mass (%) |
|---|---|
| 0.15M NaCl | 40-98 |
| Pea flour | 0-18 |
| Coconut oil | 0-50 |
| Kappa-carrageenan | 0-1 |
| Lactic Acid | 0-3 |
| GMS | 0-1 |

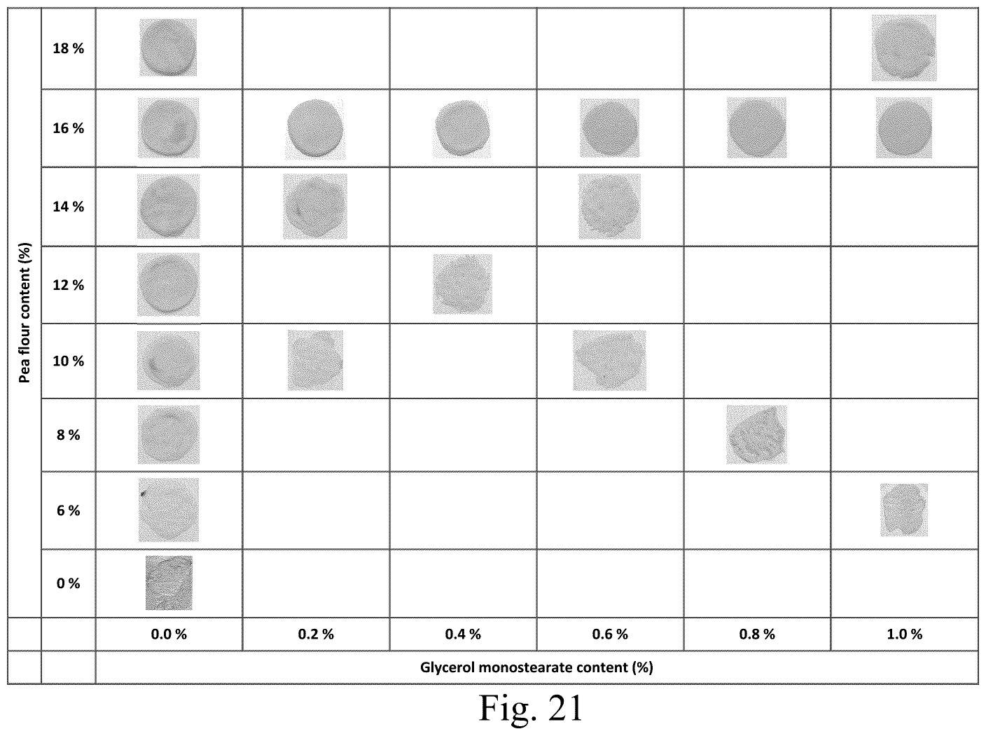

The VCAs produced in the ranges in Table 14 were subject to the second melting test protocol listed in the Methods section. The results of the melting test are shown in FIG. 21. The VCAs with pea flour content of 10% and below showed increased melting in the absence of GMS but with a reduction in perceived VCA hardness. The VCAs at 16% pea flour and higher exhibited no melting at any level of GMS up to 1%. An optimum of maximum perceived VCA hardness and maximum melting was found between 10% and 16% pea flour and greater than 0% GMS and less than 0.6% GMS shown by the spread of the melting VCA in FIG. 21.

To assess if GMS was effective in improving the melting properties of pea starch VCAs, VCAs were produced with the ingredients in the ranges shown in Table 15.

TABLE 15

| | Percentage Mass |
|---|---|
| Ingredient | (%) |
| 0.15M Sodium chloride | 40-98 |
| Pea Starch | 0-12 |
| Coconut oil | 0-50 |
| Kappa-carrageenan | 0-1 |
| Lactic Acid | 0-3 |
| GMS | 0-1 |

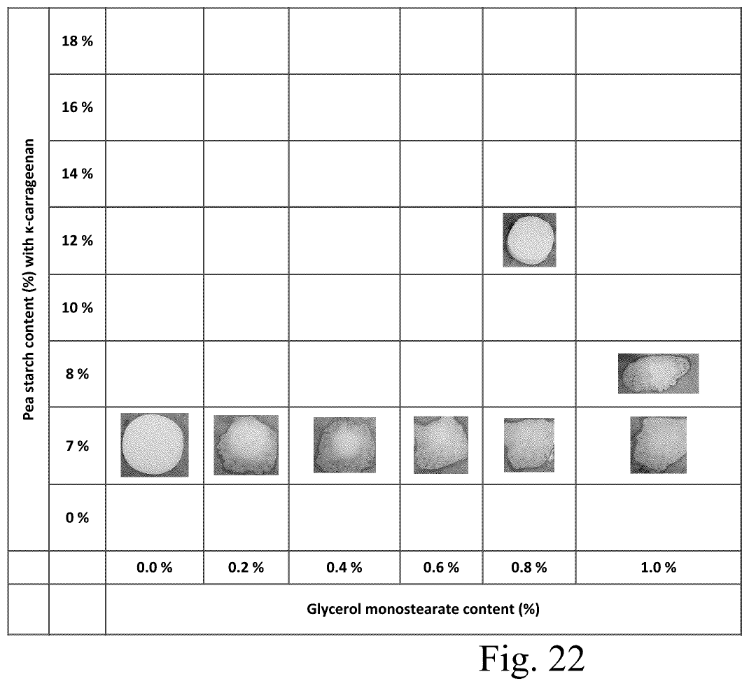

For the VCAs produced to the ranges shown in Table 15, VCAs were tested using the secondary melting method in the Methods section. The results of the melting test are shown in FIG. 22. Increasing the GMS content increases the meltability as shown by the spread of the VCA in the images. However, at 0.2% GMS the perceived hardness was less than the VCAs with GMS greater than 0.2%. Of the VCAs containing pea starch and GMS the highest melting and hardest texture was the VCA with the greatest proportion of GMS. At 12% pea flour the VCA did not melt even with an increased proportion of GMS. The optimum level of GMS in a pea starch VCA is greater than 0.2% and the optimum level of pea starch is greater than 7% and less than 12%.

Using a high proportion of yellow pea protein extract improves textural properties without inhibiting melting.

In an embodiment, the present invention relates to a vegan cheese analogue comprising a pea protein content of at least 4% by weight of a total mass of the vegan cheese analogue. In a variation, the pea protein content is comprised of any one of pea based ingredients, or pea derived ingredients or combinations thereof including but not limited to pea flours, pea protein concentrates and pea protein isolates. In a variation, the vegan cheese analogue is obtained by one or more of alkaline methods or extraction methods. In a variation, the vegan cheese analogue is made by both alkaline methods and extraction methods. In a variation, the pea fibre is an oil emulsifying agent or an oil binding agent.

In an embodiment, the vegan cheese analogue comprises pea fibre and the pea fibre improves texture relative to a vegan cheese analogue that does not comprise pea fibre. In a variation, the vegan cheese analogue comprises pea protein concentrate or pea flour, or combinations thereof, that add color to the vegan cheese analogue.

In an embodiment, the vegan cheese analogue uniformly melts. In a variation, the vegan cheese analogue is a white non-meltable cheese.

In an embodiment, the vegan cheese analogue is made from mechanically processed yellow pea. In a variation, the vegan cheese analogue further comprises modified starches.

In an embodiment, when the vegan cheese analogue melts, it has a stretchability that is within 20% the stretchability of cheddar cheese.

In an embodiment, the present invention relates to a vegan cheese analogue as described above, that further comprises a modified starch made exclusively from legume flour. In a variation, when melting the vegan cheese analogue, it has a stretchability that is within 10% the stretchability of cheddar cheese.

In an embodiment, the vegan cheese analogue further comprises GMS.

In an embodiment, the present invention relates to a method of making a vegan cheese analogue, said method comprising:
procuring dry ingredients comprising one or more of pea flour, starches, hydrocolloids, or acids and mixing dry to a homogeneous mixture;
adding an aqueous solution which optionally contains a salt to the homogenous mixture to generate a viscous uniform paste;
adding more of the aqueous solution which optionally contains the salt to the viscous uniform paste to generate a dispersion pre-mix;
pouring the dispersion pre-mix into a blender and blending the dispersion pre-mix to a dispersion mix;
heating the dispersion mix while blending the dispersion mix to generate heat processed material;
pouring the heat processed material into a mold and cooling the heat processed material to generate the vegan cheese analogue.

In a variation of the method, the dry ingredients comprise all of pea flour, starches, hydrocolloids, and acids. In a variation, the blending occurs for between 10 minutes and 2 hours. In a variation, the temperature of heating is between 40° C. and 90° C. In a variation, the temperature of heating occurs in at least two stages or at least in three stages wherein the temperature is maintained at each stage for about 30 minutes. In a variation, the temperature stages comprise a temperature stage of 50° C. and 80° C. In a variation, the temperature is gradually increased as the blending occurs. In a variation, the heat processed material further comprises one or more of coconut oil, potato starch, k-carrageenan, lactic acid, nutritional yeast, white miso, pea flour, or GMS.

The following references are incorporated by reference in their entireties for all purposes.
WO 2018/154095A1
   WO2016/172570A1
   WO 2014/110540A1

It should be understood and it is contemplated and within the scope of the present invention that any feature that is enumerated above can be combined with any other feature that is enumerated above as long as those features are not incompatible. Whenever ranges are mentioned, any real number that fits within the range of that range is contemplated as an endpoint to generate subranges. In any event, the invention is defined by the below claims.

We claim:

1. A vegan cheese analogue comprising a legume flour content of at least 13% by weight of a total mass of the vegan cheese analogue.

2. The vegan cheese analogue of claim 1, wherein the legume flour comprises pea flour and the pea flour comprises pea protein wherein the pea protein is at least partially purified to give a PPI, PPC, or combinations thereof, wherein the pea protein content is at least 4% by weight of the total mass of the vegan cheese analogue.

3. The vegan cheese analogue of claim 2, wherein the pea flour comprises pea fibre and the pea fibre serves as an oil emulsifying agent or an oil binding agent.

4. The vegan cheese analogue of claim 3, wherein the pea fibre modifies texture relative to a vegan cheese analogue that does not comprise pea fibre.

5. The vegan cheese analogue of claim 2, wherein the vegan cheese analogue comprises PPC or pea flour, or combinations thereof, that adjusts a color of the vegan cheese analogue.

6. The vegan cheese analogue of claim 1, wherein the vegan cheese analogue uniformly melts.

7. The vegan cheese analogue of claim 1, wherein the vegan cheese analogue is a white non-meltable cheese.

8. The vegan cheese analogue of claim 7, wherein the vegan cheese analogue is made from mechanically processed yellow pea.

9. The vegan cheese analogue of claim 1, further comprising modified starches.

10. The vegan cheese analogue of claim 1, wherein upon melting, the vegan cheese analogue has a stretchability that is within 20% the stretchability of a cheddar cheese.

11. The vegan cheese analogue of claim 1, further comprising a modified starch made exclusively from legume flour.

12. The vegan cheese analogue of claim 1, wherein the vegan cheese analogue is made using a number of preprocessing steps on the pea or pea flour, the preprocessing steps comprising one or more of: pre-soaking, compression popping, boiling, pressure treatment, roasting, baking, wet steaming, dry steaming, milling, pressing, protein extraction, and/or drying.

13. The vegan cheese analogue of claim 1, wherein the vegan cheese analogue further comprises one or more of glycerol monostearate, solid, semi-solid, liquid fats or mixtures thereof.

14. A method of making a vegan cheese analogue, said method comprising:
procuring dry ingredients comprising two or more of pea flour, starches, proteins, fibres, salts, hydrocolloids, or acids and mixing to a homogeneous mixture;
adding an aqueous solution to the homogenous mixture to generate a viscous uniform paste;
adding more of the aqueous solution to the viscous uniform paste to generate a dispersion pre-mix;
pouring the dispersion pre-mix into a blender and blending the dispersion pre-mix to a dispersion mix;
heating the dispersion mix while blending the dispersion mix to generate heat processed material;
pouring the heat processed material into a mold and cooling the heat processed material to generate the vegan cheese analogue.

15. The method of claim 14, wherein the dry ingredients comprise all of pea flour, starches, hydrocolloids, salts and acids.

16. The method of claim 14, wherein the blending occurs for between 10 minutes and 2 hours.

17. The method of claim 16, wherein a temperature of the heating is between 40° C. and 90° C.

18. The method of claim 17, wherein the temperature is gradually increased as the blending occurs.

19. The method of claim 16, wherein the heat processed material further comprises one or more of coconut oil, starch, fibre, protein, x-carrageenan, lactic acid, nutritional yeast, pea flour, flavor, or glycerol monostearate.

20. The vegan cheese analogue of claim 1, wherein the legume flour comprises a mixture of flours with targeted particle sizes and distribution.
